(19) United States
(12) Patent Application Publication
(10) Pub. No.: US 2012/0017996 A1
(43) Pub. Date: Jan. 26, 2012

(54) Device for portably harvesting rainwater

(75) Inventors: Mitchell T. Wenger, Los Angeles, CA (US); Thomas A. Spargo, San Ramon, CA (US)

(73) Assignee: Rainsaucers, Inc., San Ramon, CA (US)

(21) Appl. No.: 12/806,457

(22) Filed: Aug. 13, 2010

Related U.S. Application Data
(60) Provisional application No. 61/275,317, filed on Aug. 28, 2009.

(51) Int. Cl. F15D 1/00

(52) U.S. Cl. 137/1

(57) ABSTRACT

Apparatus for portable rainwater harvesting system which consists of a closed container of indeterminate size with removably sealable openings which allow for entrapment and containment of precipitation, and/or an intermediate system which may or may not connect to a catchment system. The container may have an opening near the top as an entry point for the collected rainwater and an opening with valve assembly at or near the bottom for controllably dispensing the collected rainwater. Alternately, the container may have individual openings allowing for attachment of individual collectors without intermediate device. The container may also have openings for attachment of additional containers intended to increase the overall storage capacity of the system. The intermediate device may be articulating in nature to allow the system to be used in a plurality of orientations and the catchment mechanism may be of variable size and geometry facilitating ease of attachment and ease of storage when not in use.

### RELATED APPLICATIONS

Application No. 61/275,317
Filing Date Aug. 28, 2009

Federally Sponsored Research and Development: No rights to inventions described herein are assigned based under federally sponsored research and development.

### Suggested Classification (Class and Subclass):

137/255; 137/256; 137/265; 137/376; 137/544; 137/547

### Application Type:

Utility Patent Application

### BACKGROUND OF INVENTION

Rainwater Harvesting in its simplest form, is a cistern or tank connected to a pipe which is fed by rain gutters extending from a horizontal or angled structure. While this practice can be effective in collecting large quantities of water, it has several major disadvantages. 1) In many cases the harvested rainwater contains pollutants and contaminants unique to roofs. These pollutants render the water unsuitable for potable uses. Specific harmful materials include bacteria from bird feces, roof tile chemicals, and pollutants deposited from the air. 2) The storage system must be located near the structure in order to connect to flow of water from said structure. Because of low water pressure, this limits the range of distribution of the harvested rain to the area near the point of collection. 3) In order for the storage system to connect to the collection system, modification of existing catchment devices need to be added to make the connection. In many cases, this has negative aesthetic impacts which affect widespread acceptance of traditional rainwater harvesting systems.

### BRIEF SUMMARY OF THE INVENTION

The system described herein is a low cost, easy to deploy alternative method of catching rain straight from the sky and feeding it directly into a storage system. It has a small enough footprint to facilitate deployment anywhere. Since the catchment mechanism is removable, it can be easily cleaned and stored when not in use.

Advantages over existing systems include 1.) The system is cheaper and easier to maintain because it involves no plumbing or construction. 2.) Since the system has a removable, easily cleanable catchment mechanism, the chances for contamination are greatly reduced, and 3.) no existing structure is required so anyone, anywhere can take advantage of the system to start creating their own source of clean water. In one variation of the system, it makes the rain barrel attractive enough to warrant placement even in highly visible areas.

### BRIEF DESCRIPTION OF THE SEVERAL VIEWS

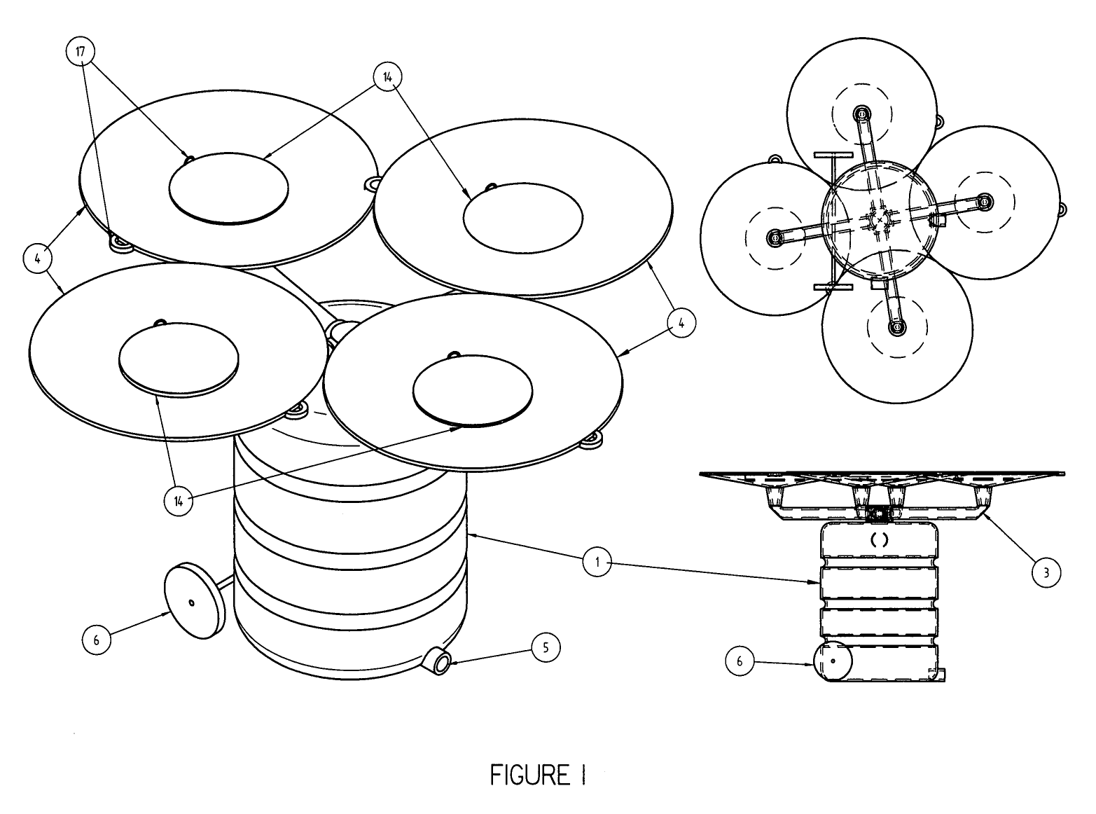

FIG. 1: Left hand view is an isometric view of an assembled system described in the claims. Right hand top view is the top of an assembled system described in the claims. Right hand lower view is an elevation view of an assembled system described in the claims.

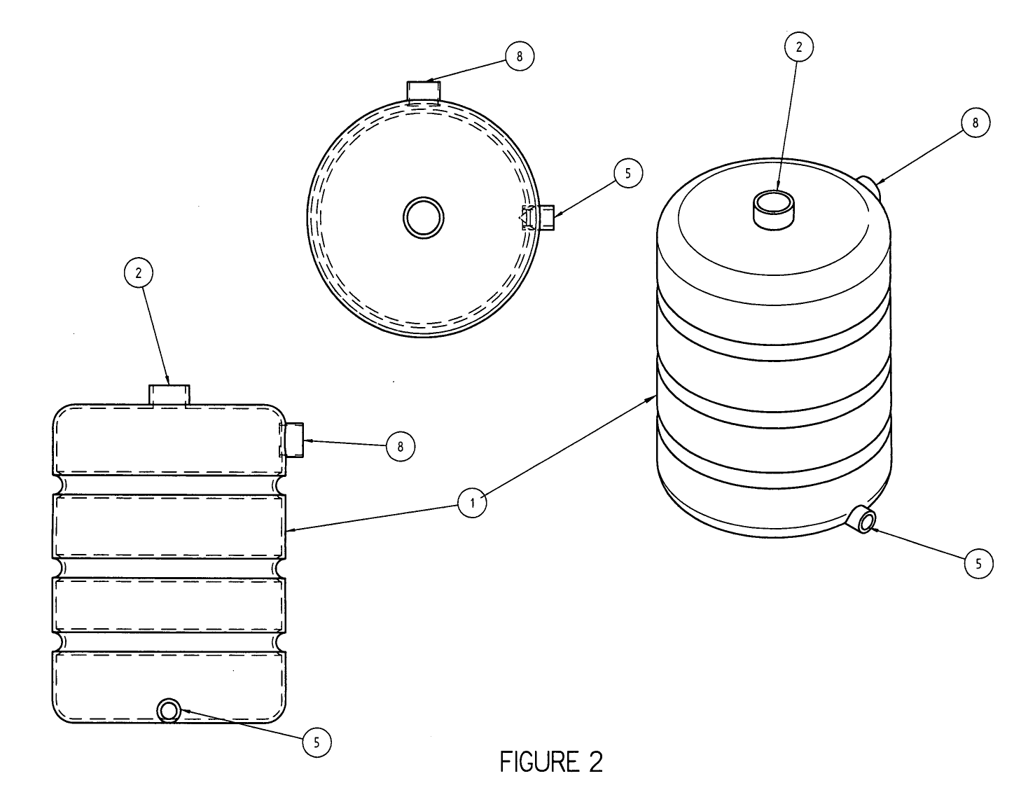

FIG. 2: Left hand view is an elevation view of a sample container device. Center top view is a plan view of an sample container device. Right hand view is an isometric view of a sample container device.

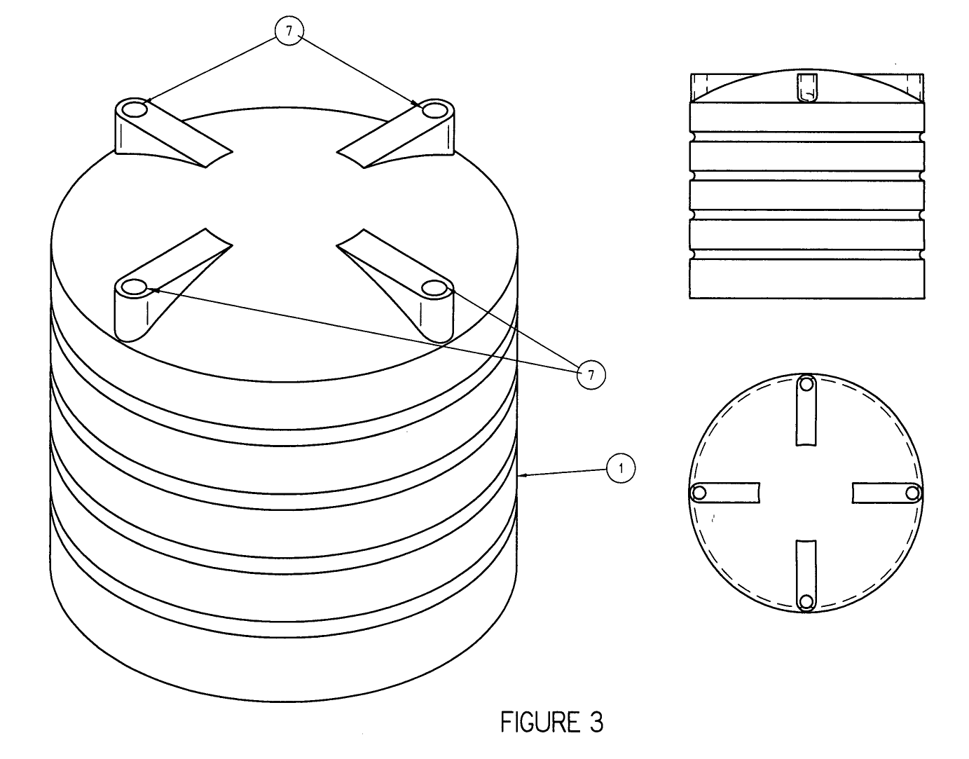

FIG. 3: Left hand view is an isometric view of a sample container device. Right top view is an elevation view of a sample container device. Right lower view is a plan view of a sample container device.

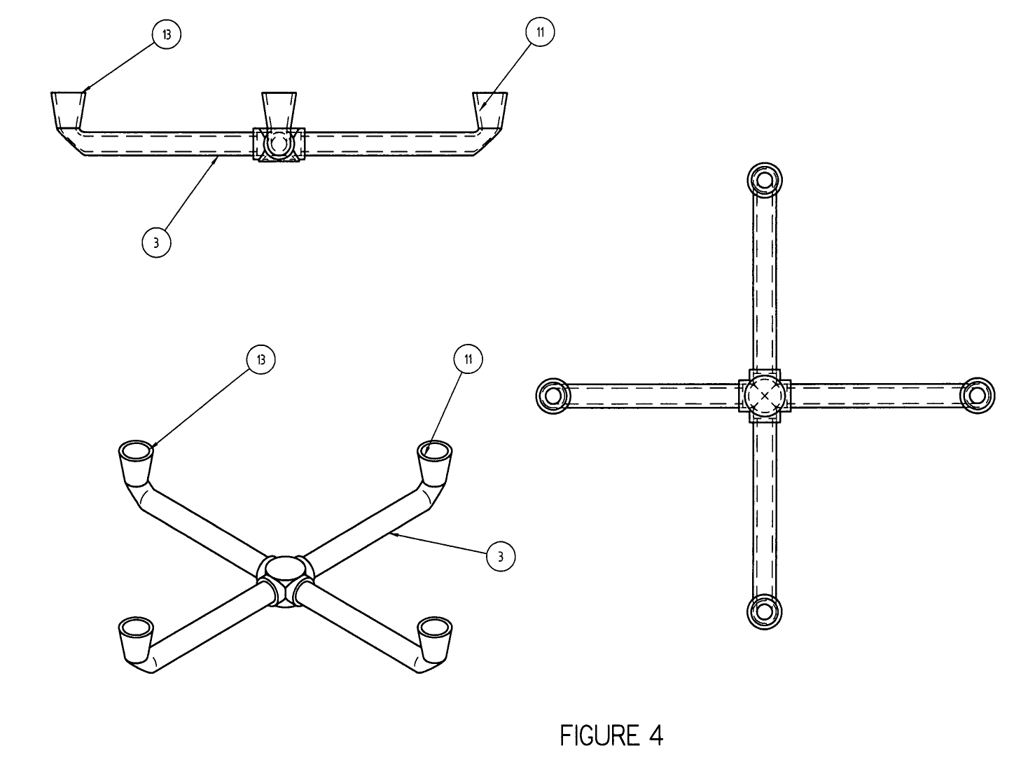

FIG. 4: Left hand top is an elevation view of a sample manifold device. Left hand lower view is an isometric of a sample manifold device. Right hand view is a plan view of a sample manifold device.

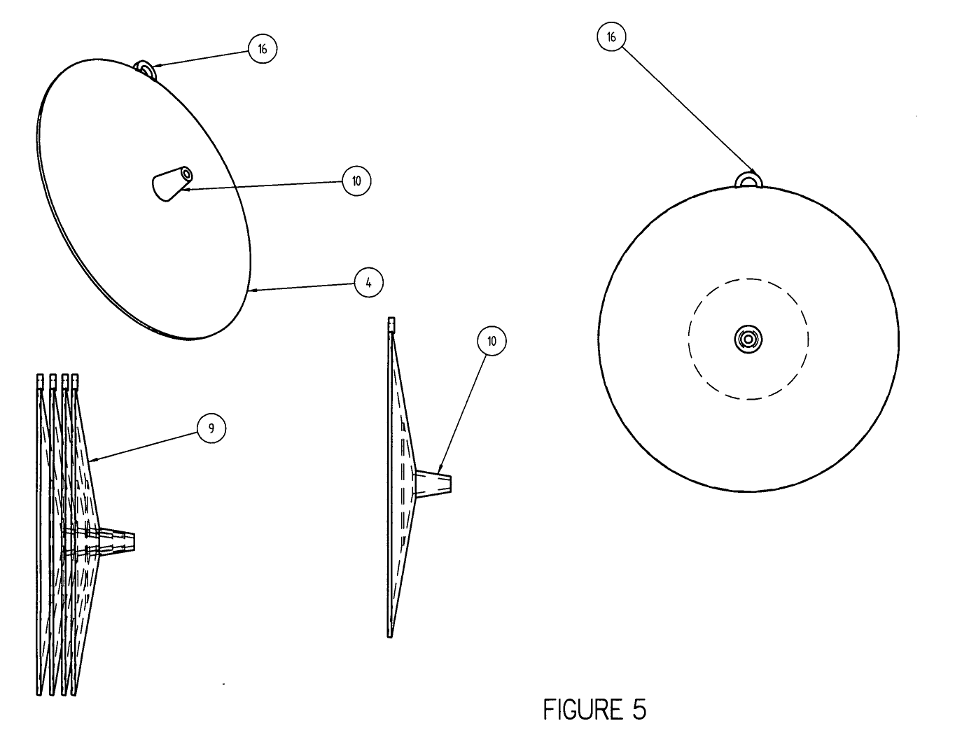

FIG. 5: Left hand lower view is a sample of collection devices stacked for storage. Left hand upper view is an isometric view of a sample collection device. Center bottom is an elevation view of a sample collection device. Right had is a plan view of a sample collection device.

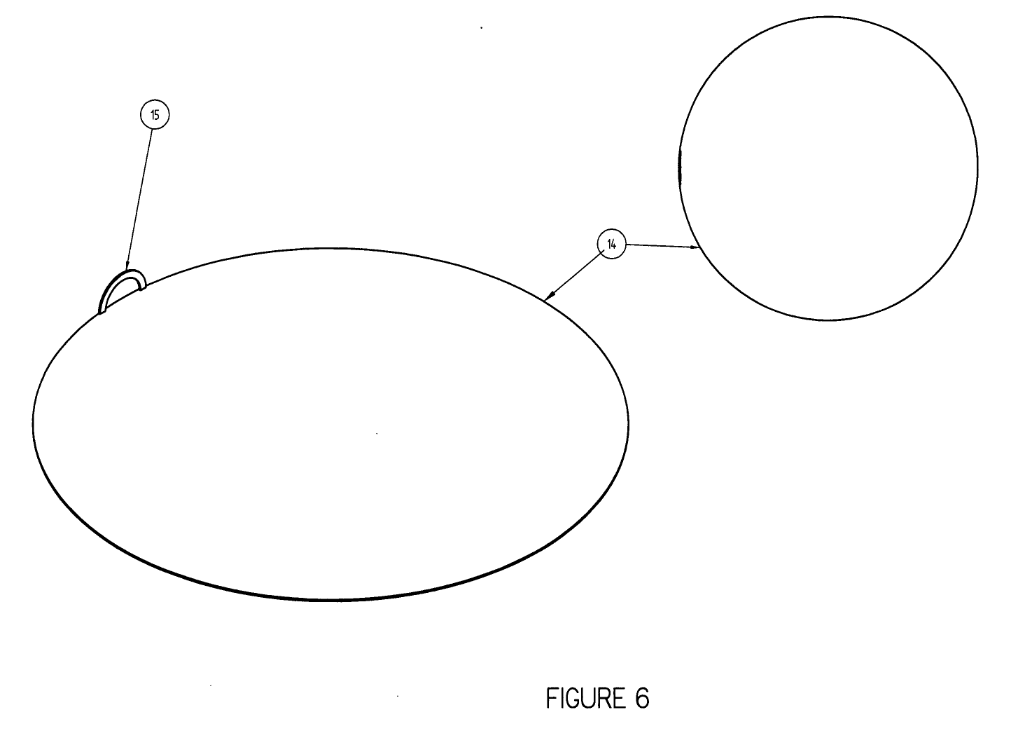

FIG. 6: Left center is an isometric view of a sample filter unit. Right hand upper view is a plan view of a sample filtration device

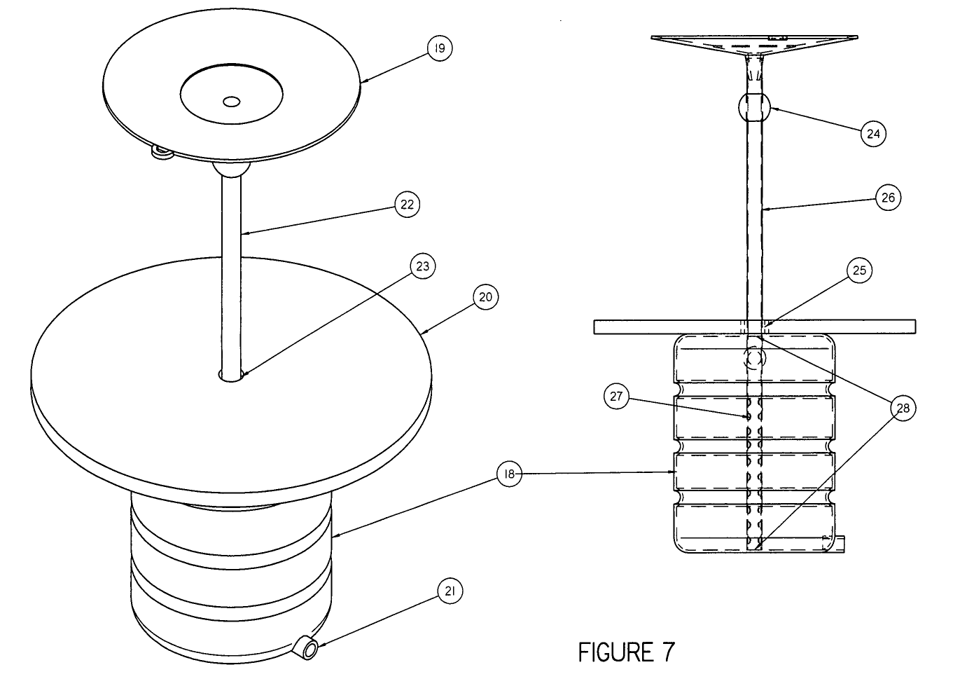

FIG. 7: Left hand is an is an isometric view of a sample water collection table system. Right hand view is an elevation view of a sample water collection table system.

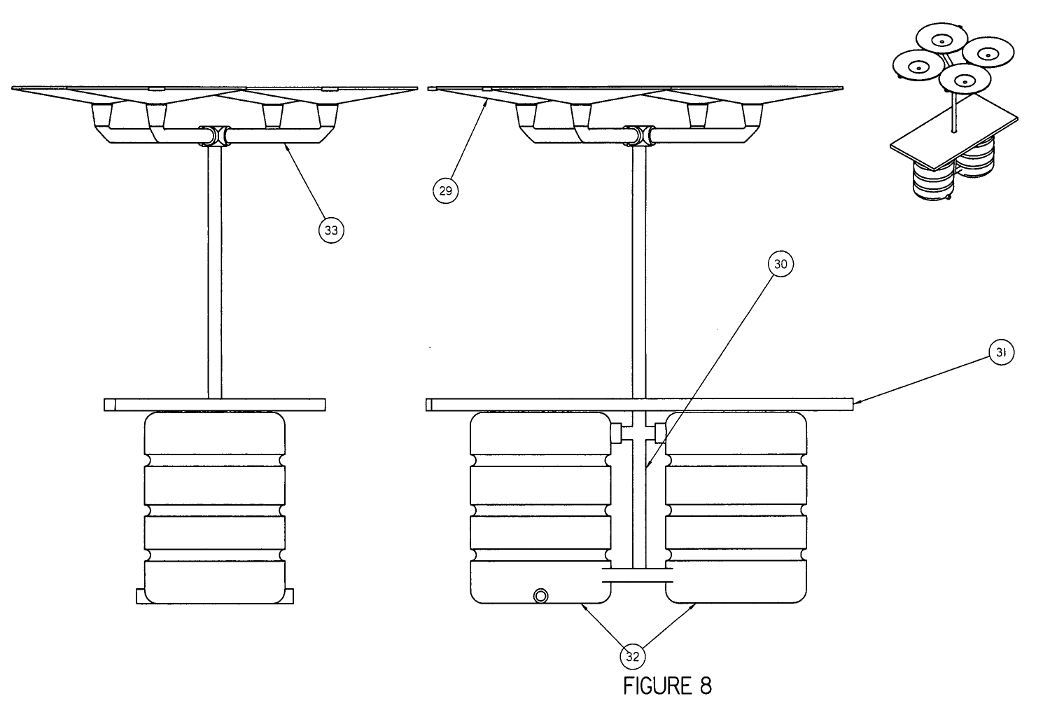

FIG. 8: Left hand is an elevation of a sample single storage water collection table with multiple collector assemblies. Center view is an elevation view of a sample water collection table with multiple collector assemblies and multiple storage units. Right hand upper is an isometric view of a sample water collection table with multiple collection assemblies and multiple storage assemblies.

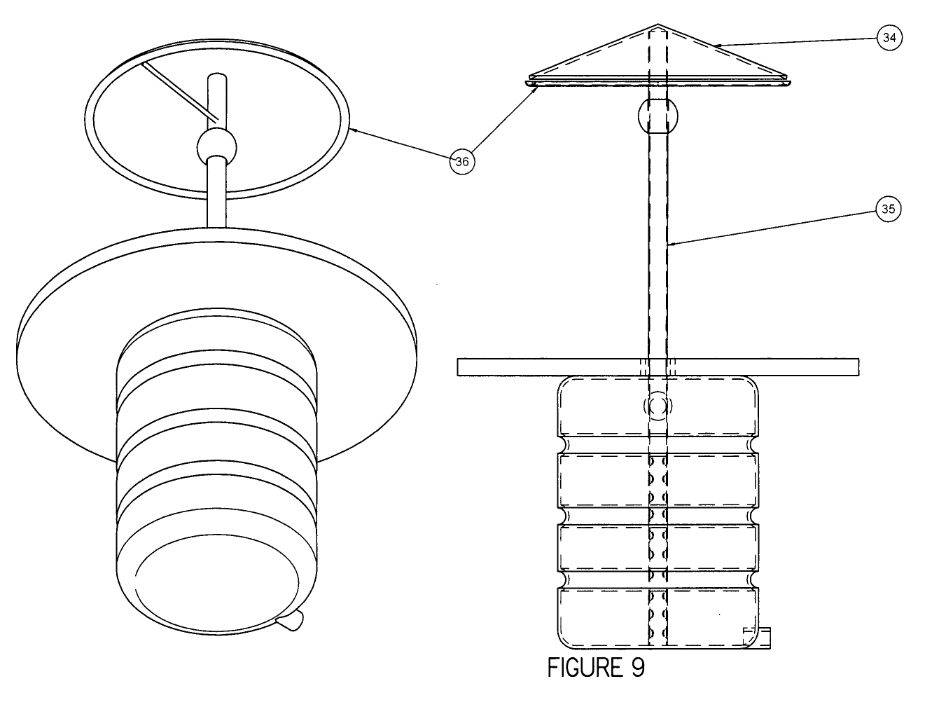

FIG. 9: Left hand is an isometric (from below) view of a sample water collection table with and inverted collection system. Right hand view is an elevation view of a sample water collection table with an inverted collection assembly.

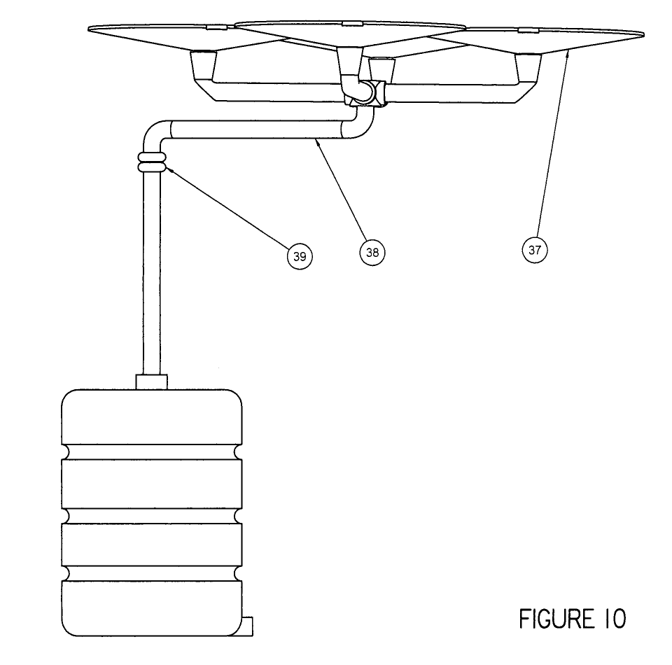

FIG. 10: Elevation view of a sample water collection assembly with offset collector assemblies shown with swivel mount.

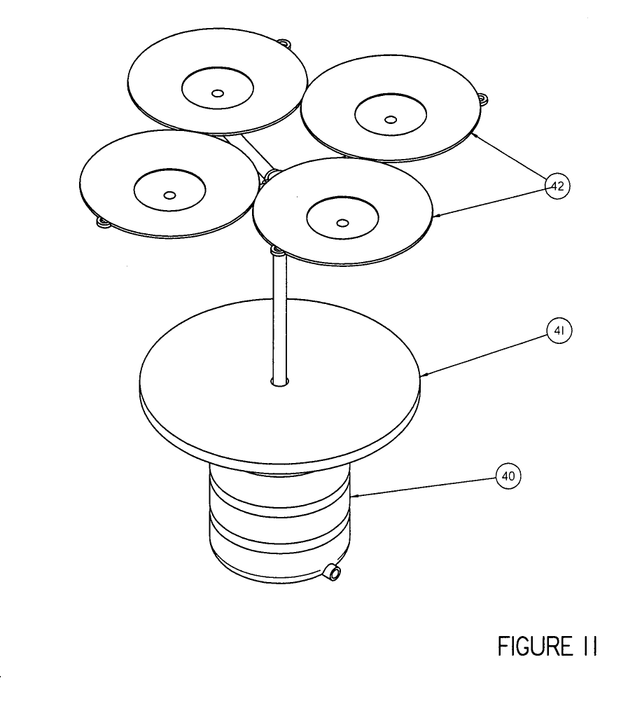

FIG. 11: Isometric view of a sample water collection table system with a multiple collector assemblies.

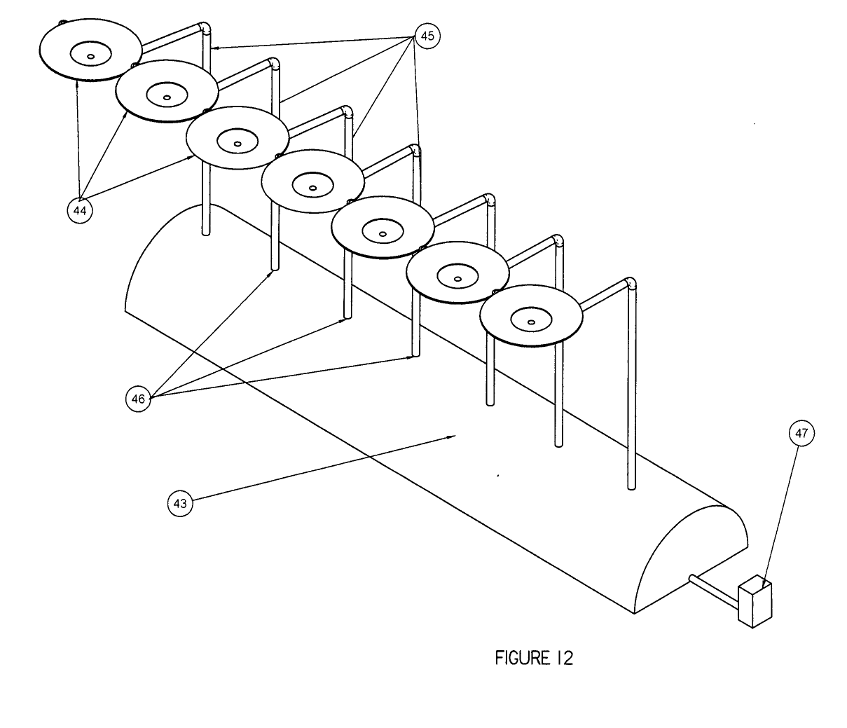

FIG. 12: Isometric view of a sample storage system with multiple collector assembles individually attached to the storage system.

What is claimed is:

1. A method of collecting and storing rainwater which includes: a closed container (1) of a certain size with removably sealable openings which allow for entrapment and containment of rainwater. Said container may have an opening (2) for a device (3) which allows for a central gathering point of a plurality of individual catchment devices (4). Said container (1) may also have a distal opening (5) at or near the bottom to allow for the attachment of a valve to allow control of the water drainage from the container. The collectors (4) are removably attached to a centralized gathering mechanism (3) which is then attached to the central gathering point (2) of the container (1).

2. A method of collecting and storing rainwater according to claim 1, wherein the container (1) is portable or moveable by means of wheels (6) attached to said container (1)

3. A method of collecting and storing rainwater according to claim 2, wherein the means of portability is by method or device which is removably attached to container (1) either by pedestal or similar.

4. A method of collecting and storing rainwater according to claim 1, wherein the container (1) may have individual openings (7) allowing for attachment of individual collectors (4) without an intermediate device.

5. A method of collecting and storing rainwater according to claim 1, wherein the container (1) may have openings (8) allowing for the permanent attachment of additional containers (1) thereby allowing for the overall expansion of storage capacity of the system.

6. A method of collecting and storing rainwater according to claim 5, wherein the container openings (8) may be attachable or removable for individual dispensation of gathered rainwater after additional containers (1) have been filled for use from the parent unit.

7. A method of collecting and storing rainwater according to claim 1, wherein the individual catchment devices (4) can be removed and stored individually or as a group (9)

8. A method of collecting and storing rainwater according to claim 7, wherein the individual catchment devices (4) can be secured to the centralized gathering device (3) by method of positive capture on surface (10) of the catchment device to surface (11) of the centralized gathering device (3)

9. A method of collecting and storing rainwater according to claim 7, wherein the individual catchment devices (4) can be secured to the centralized gathering device (3) by method of positive capture on surface (12) of the catchment device to surface (13) of the centralized gathering device (3) [different surface than claim 8]

10. A method of collecting and storing rainwater according to claim 1, wherein the individual catchment devices (4) have a filter device (14) intended to separate debris from the collected water removably fitted to the catchment device (4). Filter devices (14) may have a plurality of shapes and sizes, and may be removably fitted to the catchment device(4) by multiple means including capture in a feature of the catchment device.

11. A method of collecting and storing rainwater according to claim 10, wherein the filter device (14) is permanently or semi-permanently attached to the catchment device (4) by chain, rope or other flexible or non-flexible member (17) through device or method (15) on the filter device (14) and to device or method (16) on the catchment device (4).

12. A method of collecting and storing rainwater according to claim 1, wherein the container may have an opening at or near the proximal end (8) for the attachment of an overflow device

13. A method of collecting and storing rainwater according to claim 12, wherein the overflow device may be integrated to be inclusive of the container device (1)

14. A method of collecting and storing rainwater according to claim 10, wherein the collectors (4) are substantially non-circular in shape and of varying conical depth.

15. A method of collecting and storing rainwater according to claim 7, wherein the catchment devices (4) may be substantially manufactured as conical devices or as flat devices to be assembled to be conical in final shape.

16. A method of collecting and storing rainwater according to claim 15, wherein the catchment devices (4), being manufactured as flat devices to be assembled to final conical shape retain said final shape by the use of external fasteners.

17. A method of collecting and storing rainwater according to claim 15, wherein the catchment devices (4), being manufactured as flat devices to be assembled to final conical shape retain said final shape by the use of features manufactured into the flat shape.

18. A method of collecting and storing rainwater which includes: a closed container (18) of a certain size with removably sealable openings (25) which allow for entrapment and containment of rainwater. Said container may have an opening for a device (22) which acts as a conduit for direction of collected rainwater from a catchment device (19). Said container (18) may also have a distal opening at or near the bottom to allow for the attachment of a valve (21) to allow control of the water drainage from the container.

19. A method of collecting and storing rainwater according to claim 18, wherein the collector device is a plurality of devices (29) interconnected through a device (33) which connects the proximal end of the catchment devices (29) to the distal end of the containment devices (32)

20. A method of collecting and storing rainwater according to claim 18, wherein the top of the container device contains a surface which acts as a table top (20) through which the conduit penetrates (23) to the container device (18).

21. A method of collecting and storing rainwater according to claim 18, wherein the connection device (22) is removably attached to the table top device (20).

22. A method of collecting and storing rainwater according to claim 18, wherein the containment device (18) and table top device (20) are intended to function as an ornamental device in which a certain cosmetic appearance is desirable.

23. A method of collecting and storing rainwater according to claim 18, wherein the catchment device may be mounted on a ball joint device (24) which allows the cone angle to be in any direction including straight up (skyward), or tilted to any angle to horizontal.

24. A method of collecting and storing rainwater according to claim 18, wherein the catchment device mounted to ball joint device (24) may be a plurality of catchment devices (19).

25. A method of collecting and storing rainwater according to claim 18, wherein the catchment device (34) is placed on the connection device (35) such that it forms a negative cone angle and rainwater which is collected by the catchment device (34) is gathered by a gutter system (36) and routed to the connector device(35).

26. A method of collecting and storing rainwater according to claim 18, wherein the connection device (26) is removably or permanently mounted to both the top and the bottom of the containment device (28). The connection device (26) may have holes (27) at different locations along its length to facilitate the flow of captured water.

27. A method of collecting and storing rainwater according to claim 18, wherein the storage system is a plurality of container devices (32) which may be connected by interconnection system (30).

28. A method of collecting and storing rainwater according to claim 27, wherein the system is comprised of a plurality of storage devices removably attached to a table top device (31). The table top device (31) may be removably part of the containment device or the interconnection system (30).

29. A method of collecting and storing rainwater according to claim 27, wherein the storage devices (32) and table top device (31) are intended to function as an ornamental device in which a certain cosmetic appearance is desirable.

30. A method of collecting and storing rainwater according to claim 27, wherein a single containment device (40) and table top device (41) may be attached to a singular or plurality of catchment devices (42)

31. A method of collecting and storing rainwater according to claim 18, wherein a singular or plurality of catchment devices (37) may be mounted to a swivel device (39) allowing the catchment devices (37) and a connection device (38) to swivel to any desired angle.

32. A method of collecting and storing rainwater according to claim 31, wherein the connection device (38) may be a plurality of different shapes and construction methods.

33. A method of collecting and storing rainwater which includes: a closed container (43) of a certain size with removably sealable openings which allow for entrapment and containment of rainwater. Said container may have openings (46) for a singular or plurality of devices (45) which allows for a plurality of individual collectors (44). Said container (43) may also have a distal opening at or near the bottom to allow for the attachment of a pump or siphon device (47) to allow water drainage from the container.

34. A method of collecting and storing rainwater according to claim 33, wherein the catchment devices may be attached to individual connector devices (45) or plurality of catchment devices (44) may be attached to a single connection device as described in claims 19 and 23.
